(19) United States
(12) Patent Application Publication
(10) Pub. No.: US 2008/0295372 A1
(43) Pub. Date: Dec. 4, 2008

(54) DECORATIVE ASSEMBLIES

(76) Inventors: Yaser M. Aldineh, Dayton, OH (US); Jill A. Aldineh, Dayton, OH (US); Maxine M. Pancher, Dayton, OH (US); William T. Pancher, Dayton, OH (US)

Correspondence Address: BELL, BOYD & LLOYD, LLP, P.O. Box 1135, CHICAGO, IL, 60690, US

(21) Appl. No.: 11/756,224

(22) Filed: May 31, 2007

(51) Int. Cl. G09F 7/04

(52) U.S. Cl. 40/600

(57) ABSTRACT

A decorative assembly that includes a first and second multilayered portions. The first layer of each portion is comprised of a releasably adherable material for adhering each portion to a panel. The second and third layers of each portion are comprised of decorative material and the third layer is not co-extensive with the second layer. The first portion is removably adhered to a second panel. The first and second portions of the decorative assembly form a composite image having a three-dimensional appearance when the panels are moved into a closed position.

### BACKGROUND

The present disclosure generally relates to releasably adherable decorative assemblies. In particular, the present disclosure generally relates to magnetic decorative assemblies that can be removably affixed to panel doors and to methods of manufacturing and displaying the same.

Sports fans and holiday enthusiast often enjoying decorating their environment, such as their home, office, car, etc., to show support for their favorite sports team or to celebrate a holiday or season. Sports fans typically decorate by displaying images associated with their favorite sports team, and holiday enthusiast often decorate by displaying images associated with a favorite holiday or season, such as images of Christmas trees, Easter bunnies, patriotic symbols, etc.

Often super-fans and robust holiday enthusiast desire to display large decorations to express how much they support their team or enjoy a holiday season. They also prefer that the display have stylish characteristics, such as a three-dimension appearance or multiple colors, and that the display be conveniently attachable and removable. Typically, such large decorations are required to be attached to or held by an object that has a large and generally flat surface. Some objects that have large, generally flat surfaces and would appear to be well-suited for attaching large decorations thereto include garage doors, cabinet doors, cars and closet or entryway doors. However, it often is difficult to attach large decorations to the surfaces of such objects without impairing the operation of the object.

For example, while all of the above mentioned objects have a large surface, the surface is typically created by a plurality of panels. In a closed position, the panels cooperate to form a generally continuous flat surface having minor seams between the panels. In an opened position, the panels are moved in relation to each other and gaps form between the panels. For example, in the context of garage doors, a garage door is typically comprised of a series of panels that are hingedly connected together. When the garage door is in the closed position, the panels form a generally flat surface that would appear to be well suited for attaching a decorative display thereto. However, when the door is moved into the opened position, the panels pivot relative to each other and gaps are created between the panels. Because of the relative movement of the panels with respect to each other during the operation of the garage door, it is difficult to display a large decorative image that spans more than one panel without impairing the operation of the garage door.

Therefore there remains a need for large, stylish decorative displays that can be conveniently attached to and removed from a surface comprised of multiple panels, which move with respect to one another, without interfering with the operation or movement of the panels.

### SUMMARY

The present disclosure is generally related to three-dimensional decorative assemblies or displays that can be removably adhered to a surface formed from a plurality of movable panels without substantially effecting the movement or operation of the panels. Such surfaces can include the exterior surface of a garage door, adjacent cabinet doors, a car door, or bi-fold doors.

The decorative assemblies can include a plurality of multilayered substrates that when placed in a closely adjacent relation, form a composite image having a three-dimensional appearance. Such images can include images of a team mascot or an image associated with a holiday or season. The first layer of each substrate includes a releasably adherable material, such as a sheet of magnetic material or a sheet of material having a releasable adhesive disposed thereon. The first layers can be employed to releasably adhere the substrates to a surface formed by a plurality of adjacent panels. Typically, the panels are moveable between a first or opened position wherein at least some of the panels are separated from an adjacent panel by a gap and a second or closed position wherein the panels create a generally flat surface. In one embodiment, each substrate is attached to a different panel. By moving the panels into the closed position, the multilayered substrates are moved into a closely adjacent relation to form the composite image.

The three-dimensional appearance of the composite image can be formed from a second and third layer of the substrates. The second and third layers can be comprised of a decorative material, such as craft foam. The third layer is not coextensive with and extends from the second layer to give the composite image a three-dimensional appearance.

One aspect of the present disclosure is related to a decorative assembly comprising first and second multilayered portions wherein each portion includes a first layer, a second layer and a third layer. The first layer of each portion is comprised of a releasably adherable material, such as a magnetic material. The second layer comprises a decorative material and the third layer comprises a decorative material that is not coextensive with the second layer. The first portion can be removably adhered to a first panel and the second portion can be removably adhered to a second panel which is adjacent to the first panel. The panels are movable between a first opened position and a second closed position. When the first and second panels are moved into the closed position, the first and second portions come together to form a composite image wherein the second and third layers give the composite image a three-dimensional appearance.

Yet another aspect of the present disclosure relates to a method of manufacturing a decorative display. The method comprises providing a first layer of releasably adherable material and attaching a second layer of decorative material thereto to form a substrate. A third layer of decorative material is then attached to the second layer in a non-coextensive manner so that the second and third layers form an image having a three dimensional appearance. The substrate is then separated into portions wherein each portion is sized to be releasably adhered to a panel of a multipaneled object. The method could further include adhering each portion of the substrate to separate panels forming a surface.

A further aspect of the present disclosure is related to a method of displaying a decorative image. The method comprises releasably adhering a first multiple layer substrate with at least two layers not coextensive with each other to a first panel, and releasably adhering a second multiple layer substrate with at least two layers not coextensive with each other to a second panel. The first and second panels are then moved to a closed position and a composite image is formed by the first and second substrates.

Additional features and advantages are described herein, and will be apparent from, the following Detailed Description and the figures.

### BRIEF DESCRIPTION OF THE FIGURES

FIG. 1 is a perspective view of a garage door having one embodiment of the decorative assembly of the present disclosure adhered thereto;

FIG. 2A is a cross-sectional view of the garage door and decorative assembly of FIG. 1 shown with the garage door in the closed or second position;

FIG. 2B is a cross-sectional view of the garage door and decorative assembly of FIG. 1 shown with the garage door partially in the first or opened position;

FIG. 2C is an enlarged cross-sectional view of the first panel of the garage door and the first portion of the decorative assembly;

FIG. 3 is an exploded view of the decorative display shown in FIG. 1;

FIG. 4 is a perspective view of a bi-fold door having one embodiment of a decorative assembly of the present disclosure adhered thereto;

FIG. 5 is an elevational side view of a car having one embodiment of a decorative assembly of the present disclosure adhered to the door and side panel of the car;

FIG. 6 is a side view of a mini-van having one embodiment of a decorative assembly adhered to the door and the side panel of the mini-van; and

FIG. 7 is a front elevational view of a cabinet having one embodiment of a decorative assembly adhered to the doors of the cabinet.

### DETAILED DESCRIPTION

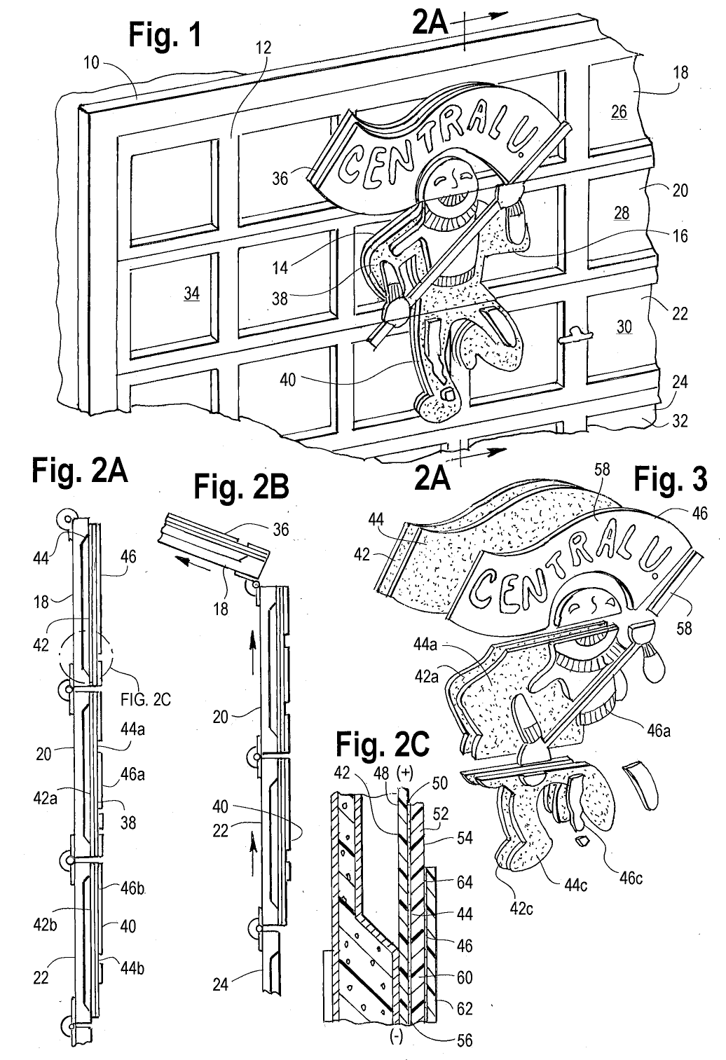

FIGS. 1 through 2B illustrate a residential garage 10 including an overhead garage door 12 having one embodiment of a decorative assembly or display 14 of the present disclosure adhered thereto. The typical residential overhead garage door is comprised of a plurality of adjoining panels having a vertical arrangement, i.e., positioned one on top of another. Currently, the standard height of such panels is about 21 inches, but many garages are custom built so the height of the panel may vary. The adjoining panels are pivotly movable with respect to one another so that the garage door panels can be moved between an opened position (FIG. 2B illustrates the garage door in a partially opened position) and a closed position (FIG. 1 and FIG. 2A). In the illustrated embodiment, the garage door 12 includes four panels 18, 20, 22 and 24. The four panels 18, 20, 22, 24 each have a surface 26, 28, 30 and 32, respectively, that form a generally flat exterior surface 34 of the garage door 12 when the panels are in the closed position. The term “generally flat” as used herein refers to the overall configuration of the surface 34 of the garage door 12 created by the adjoining panels 18, 20, 22, 24 lying generally in the same plane and is not meant to be a reference to the texture of the surfaces 26, 28, 30, 32 of the individual panels which may include grooves, ridges and hills and valleys.

In the illustrated embodiment, the decorative assembly 14 is adhered to the exterior surface 34 of garage door 14 and spans three panels, 18, 20 and 22. The decorative assembly 14 displays an image 16. The image 16 can be any number of images including, for example, the image of a team mascot, a holiday symbol or a personal message, such as “just married” or “congratulations.” Furthermore, the decorative assembly 14 could be a variety of sizes. For example, in the illustrated embodiment, the decorative assembly 14 spans three garage door panels and has a height of about 60 inches. In other embodiments, the decorative assembly can have at least one dimension that is about 12 inches or greater, or about 24 inches or greater, or about 48 inches or greater. For instance, the decorative assembly can be about 12 inches by 12 inches, about 24 inches by 24 inches or about 48 inches by 48 inches or any other combination of dimensions.

Referring to FIGS. 1, 2A, 2B and 3, the decorative assembly 14 can be comprised of three portions or sections, a first portion 36, a second portion 38 and a third portion 40. It will be understood that the decorative assembly can be comprised of any number of portions and that the number of portions can vary depending on the size of the decorative assembly and the surface to which the decorative assembly is configured to be adhered. In one embodiment the decorative assembly can be divided into at least two portions and in another embodiment, the decorative assembly can be divided into four or more portions.

Turning to FIGS. 2A, 2B, 2C and 3, each of the portions 36, 38, 40 can be comprised of a multilayered substrate. The first portion 36 includes a first layer 42, a second layer 44 and a third layer 46. The first layer 42 can be comprised of a releasably adherable, flexible material, such as a sheet of magnetic material. Alternatively, the first layer 42 can be a sheet of material including a releasable adhesive that is capable of releasably adhering to the surface of a panel. In one embodiment, the first layer 42 can have a thickness of about 0.5 mm to about 1.5 mm. The first layer also includes opposed surfaces 48 and 50 (FIG. 2C). The surface 48 is adapted to be adhered to a panel to removably secure the portion to the panel.

The second layer 44 can be comprised of a decorative material, such as craft foam or plastic. In one embodiment, the second layer 44 can have a thickness of about 3 mm to about 5.5 mm. The second layer 44 includes opposed surfaces 52 and 54 (FIG. 2c). Surface 52 of the second layer 44 is attached to surface 50 of the first layer 42, preferably by an adhesive 56. The second layer 44 can be coextensive with the first layer 42, or the second layer can be non-coextensive with the first layer. Furthermore, the second layer 44 can be comprised of one continuous piece of decorative material or the second layer can be comprised of multiple abutting pieces of decorative material. In one embodiment, the second layer 44 is comprised of a single color, however, the second layer could also be comprised of multiple colors. For example, the second layer 44 could be comprised of two or more pieces of decorative material wherein each piece is a different color.

The third layer 46 can be comprised of a decorative material, such as craft foam or plastic. The third layer 46 is attached to the second layer 44 in a non-coextensive manner, i.e., the third layer is not coextensive with the second layer. In one embodiment, the third layer 46 can have a thickness of about 2 mm to about 3.5 mm. The third layer 46 may be comprised of a plurality of pieces or component parts 58 (FIG. 3) that may or may not be abutting and may or may not have varying thickness. Alternatively, the third layer can also be comprised of a single continuous piece of material. The third layer 46 includes opposed surfaces 60 and 62. Surface 62 of the third layer 46 is preferably attached to surface 54 of the second layer 44 by an adhesive 64.

The second layer 44 and the third layer 46 form the image 16 that is displayed by the decorative assembly 14. The third layer 46 extends or projects from the second layer 44 so that the second and third layer give the image 16 a three-dimensional appearance. The third layer 46 can vary in thickness to provide more or less depth to the image 16 as desired. For example, when the third layer 46 is comprised of component parts 58, the component parts can vary in thickness so as to change the depth of the image. In the alternative, a fourth layer or other additional layers could be attached to add depth to the image.

The second portion 38 can include a first layer 42a, a second layer 44a and a third layer 46a, and the third portion 40 can include a first layer 42b, a second layer 44b and a third layer 46b. The layers 42a, 44a and 46a of the second portion 38 and the layers 42b, 44b and 46b of the third portion 40 have generally the same construction and generally similar characteristics as the layers of the first portion discussed above.

One embodiment of a method of using and displaying the decorative assembly 14 will now be generically described in relation to decorating the garage door 12. It will be understood that the methods and principles described herein generally could be applied to displaying the decorative assembly on any surface formed from a plurality of panels.

To display the image 16 of the decorative assembly 14, referring to FIGS. 1, 2A and 2B, the first portion 36 of the assembly is releasably adhered to panel 18 of garage door 12, the second portion 38 of the assembly is releasably adhered to panel 20 and the third portion 40 of the assembly is adhered to panel 22. When the first layers 42a, 42b and 42c of each of the portions 36, 38 and 40 are comprised of a magnetic material and the panels are comprised of a metal, the portions can be magnetically adhered to the panels by contacting first layer 42a, 42b, 42c of each of the portions against surfaces 26, 28, 30 of panels 18, 20, 22. The panels 18, 20, 22 are then moved to the closed position (FIGS. 1 and 2A) to display composite image 16. As can be seen in FIGS. 2A and 2B, the panels of the garage door can be moved between the opened position and the closed position without any interference from the decorative assembly.

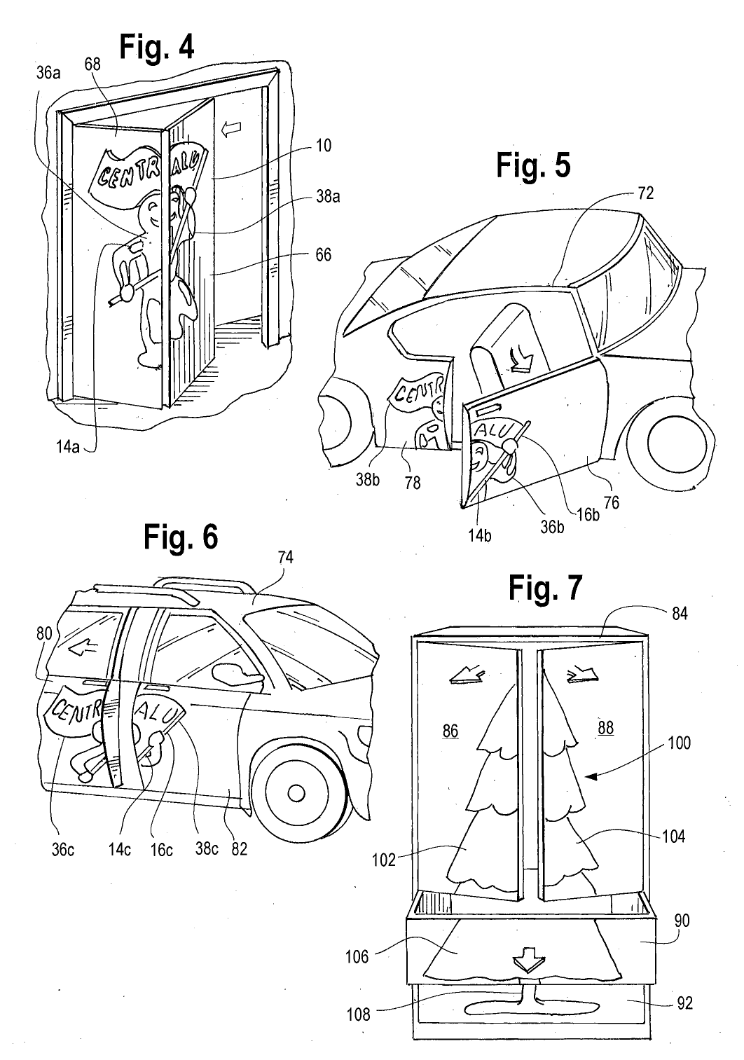

The decorative assembly of present disclosure can be employed to decorate other items having adjacent panels that are movable with respect to one another. For example, FIG. 4 illustrates a bi-fold door 66 having an embodiment of a decorative assembly 14a attached thereto. The bi-fold door 66 has a first panel 68 and a second panel 70. In this embodiment, the decorative assembly 14a includes a first portion 36a and a second portion 38a. The first portion 36a is removably adhered to a first panel 68 of the bi-fold door 66 and the second portion 38a is removably adhered to a second panel 70. In contrast to the pervious embodiment wherein the portions of the decorative assembly had a vertical relationship, the portions of this embodiment have a side-by-side relationship. When the panels 68, 70 are moved into the closed position, the first portion 36a and the second portion 38a are moved together to display the image 16a.

In FIG. 5 a decorative assembly 14b is removably adhered to a car 72 and in FIG. 6 the decorative assembly 14c is adhered to mini-van 74. In FIG. 5, the decorative assembly 14b spans the door 76 and the side panel 78 of the car 72. The decorative assembly 14b includes a first portion 36b removably adhered to the door 76 and a second portion 38b removably adhered to the side panel 78. When the door 76 is moved into the closed position, the first and second portions 36b, 38b are moved into a close adjacent relationship to display the composite image 16b. In FIG. 6, a first portion 36c of the decorative assembly 14c is removably adhered to the sliding door 80 of the mini-van 74 and the second portion 38c is removably adhered to the side panel 82. When the sliding door 80 is moved into the closed position, the decorative assembly 14c displays the composite image 16c.

FIG. 7 illustrates a cabinet 84, for example a filing cabinet, that has panels that move a variety of directions with respect to one another. For instance, panels 86 and 88 pivot toward and away from each other. On the other hand, panels 90 and 92 move back and forth relative to the other panels. In this embodiment, the decorative assembly 100 includes four portions, a first portion 102, a second portion 104, a third portion 106 and a fourth portion 108. The portion 102, 104, 106 and 108 are removably adhered to panels 86, 88, 90 and 92, respectfully. When the panels are moved into the closed position, the decorative assembly 100 displays image 112. In this embodiment, the portions 102, 104, 106 and 108 of the decorative assembly 100 have both a vertical relationship and a side-by-side relationship.

In one method of manufacturing a decorative assembly of the present disclosure, the first layer of releasably adhesive material is attached preferably by an adhesive, to a second layer of decorative material, to form a substrate. A third layer of decorative material is attached to the second layer in a non-coextensive manner so that the second and third layers create an image having a three dimensional appearance. The substrate is then separated into portions that are sized to be removably adhered to a panel. Depending on the sizes of the panels, the substrate could be separated into portions having substantially the same size, or the substrate could be separated into portions having varying sizes. The ordering in which the steps of the method would vary. For example, the substrate formed by the first and second could be separated prior to attachment of the third layer to the second layer.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A decorative assembly, comprising:
at least a first portion and a second portion wherein each portion has multiple layers including a first layer of a releasably adherable material, a second layer of a decorative material and a third layer of a decorative material, the third layer not coextensive with the second layer;
the first portion configured to be removably adhered to a first panel and the second portion configured to be removably adhered to a second panel, wherein the first portion and the second portion are configured to removably adhere to both flat and non-flat surfaces, and wherein the first panel is adjacent the second panel and the panels are movable with respect to each other between an open position and a closed position; and
the first portion and the second portion forming a composite image when the panels are in the closed position, the second layer and the third giving the composite image a three-dimensional appearance.

2. The decorative assembly of claim 1 wherein the first layer of each portion comprises a magnetic material.

3. The decorative assembly of claim 1 wherein at least one of the first and second portions of the third layer includes a plurality of component parts.

4. The decorative assembly of claim 1 wherein the first portion is configured to be magnetically adhered to the first panel and the second portion is configured to be magnetically adhered to the second panel.

5. The decorative assembly of claim 1 wherein the panels pivot with respect to each other.

6. The decorative assembly of claim 1 wherein at least one of the panels moves forward and backward with respect to the other panel.

7. The decorative assembly of claim 1 wherein the second layer of decorative material comprises foam.

8. The decorative assembly of claim 1 wherein the third layer of decorative material comprises foam.

9. (canceled)

10. The decorative assembly of claim 1 wherein the composite image is about 12 inches or greater in at least one dimension.

11. The decorative assembly of claim 1 further comprising a third portion which is configured to be removably adhered to a third panel.

12. A method of manufacturing a decorative display, comprising:
providing a first layer of releasably adherable material;
attaching a second layer of decorative material to the first layer to form a substrate;
attaching a third layer of decorative material to the second layer in a non-coextensive manner, the second and third layers forming an image having a three-dimensional appearance; and
separating the substrate into portions wherein each portion is sized to be releasably adhered to a panel of a multipaneled object, and wherein each portion is configured to releasably adhere to both flat and non-flat surfaces.

13. The method of claim 12 comprising magnetically adhering the first layer to a panel.

14. The method of claim 12 comprising attaching the second layer to the first layer with an adhesive material.

15. The method of claim 12 comprising attaching the third layer to the second layer with an adhesive material.

16. The method of claim 12 wherein the multipaneled object is a garage door.

17. A method of displaying a decorative image, comprising:
releasably adhering a first multiple layer substrate with at least two layers not coextensive with each other to a first panel that is movable with respect to a second panel;
releasably adhering a second multiple layer substrate with at least two layers not coextensive with each other to the second panel, wherein the first and second multiple layer substrates are configured to releasably adhere to both flat and non-flat surfaces;
moving the first panel and the second panel to a closed position, and
forming, with the first and second multiple layer substrates, a composite image having a three-dimensional appearance.

18. The method of claim 17 wherein the multiple layer substrates are releasably adhered to the panels by magnetic forces.

19. The method of claim 17 wherein the first and second panels are pivotly movable to the closed position.

20. The method of claim 12 wherein the panels are garage door panels.
